(19) United States
(12) Patent Application Publication
(10) Pub. No.: US 2023/0108530 A1
(43) Pub. Date: Apr. 6, 2023

(54) PARKING ASSISTANCE DEVICE

(71) Applicants: AISIN CORPORATION, Kariya (JP); TOYOTA JIDOSHA KABUSHIKI KAISHA, Toyota-shi (JP)

(72) Inventors: Motokatsu TOMOZAWA, Kariya-shi (JP); Shinya SANNODO, Toyota-shi (JP); Shinya OTANI, Nagoya-shi (JP)

(73) Assignees: AISIN CORPORATION, Kariya (JP); TOYOTA JIDOSHA KABUSHIKI KAISHA, Toyota-shi (JP)

(21) Appl. No.: 17/953,798

(22) Filed: Sep. 27, 2022

(30) Foreign Application Priority Data
Sep. 30, 2021 (JP) 2021-162024

(51) Int. Cl. B60W 30/06

(52) U.S. Cl. CPC B60W 30/06; B60W 2710/18

(57) ABSTRACT

A parking assistance device includes: a traveling assistance control unit that causes a vehicle to automatically travel to a designated parking area and park the vehicle; a reception unit that receives an operation signal for shifting to a state in which traveling control by the traveling assistance control unit can be executed from an operation unit provided in a vehicle interior of the vehicle; and a braking switching unit that switches a braking device that maintains a stop state of the vehicle to a braking force generating state in a case where the operation signal is received.

### CROSS REFERENCE TO RELATED APPLICATIONS

This application is based on and claims priority under 35 U.S.C. § 119 to Japanese Patent Application No. 2021-162024, filed on Sep. 30, 2021, the entire content of which is incorporated herein by reference.

### TECHNICAL FIELD

The present disclosure relates to a parking assistance device.

### BACKGROUND DISCUSSION

A known vehicle control system is disclosed in JP 6564269 B2 in which a key operation free system that performs ID collation of an electronic key by narrow-area wireless communication in response to communication from a vehicle and performs various types of control is mounted. For example, a system has been devised in which in a case where a stop of a vehicle is detected, a select lever of a transmission is at a position other than parking, and a vehicle power source is in an on state, and in a case where that it has been confirmed that a user carrying an electronic key has got off, an electric parking brake mechanism, a service brake mechanism, a select lock mechanism, or the like are operated to disable traveling of the vehicle.

Meanwhile, in recent years, a vehicle automatic traveling assistance technique has been put into practical use. The automatic traveling assistance may be executed in a state where the driver (passenger) is present inside the vehicle, or may be executed in a state where the driver is present outside the vehicle. In particular, in a case where automatic parking assistance is executed in a state where the driver is outside the vehicle, for example, in which the vehicle is automatically moved to a parking space, it is necessary to reliably maintain the braking state of the vehicle. However, in the case of the system as in JP 6564269 B2, since the braking mechanism that disables traveling of the vehicle is operated after it is confirmed that the user (driver) has got off the vehicle, there is a problem that the vehicle may move until the actual getting off is detected after the user starts the getting off operation.

A need thus exists for a parking assistance device which is not susceptible to the drawback mentioned above.

### SUMMARY

A parking assistance device includes: a traveling assistance control unit that causes a vehicle to automatically travel to a designated parking area and park the vehicle; a reception unit that receives an operation signal for shifting to a state in which traveling control by the traveling assistance control unit can be executed from an operation unit provided in a vehicle interior of the vehicle; and a braking switching unit that switches a braking device that maintains a stop state of the vehicle to a braking force generating state in a case where the operation signal is received.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exemplary schematic perspective view illustrating a state in which a part of a vehicle interior of a vehicle equipped with a parking assistance device according to an embodiment is seen through;

FIG. 2 is an exemplary schematic plan view of the vehicle equipped with the parking assistance device according to the embodiment;

FIG. 3 is an exemplary schematic block diagram illustrating a functional configuration of a control system of the vehicle including the parking assistance device according to the embodiment;

FIG. 4 is an exemplary schematic block diagram illustrating a configuration of the parking assistance device according to the embodiment;

FIG. 5 is an exemplary flowchart illustrating a flow of processing in a case where the parking assistance device according to the embodiment confirms getting off of a passenger, performs control transfer, and executes parking assistance control;

FIG. 6 is an exemplary diagram illustrating a transition of a braking force of the braking control when the parking assistance control is executed in the parking assistance device according to the embodiment; and

FIG. 7 is an exemplary diagram illustrating a transition of an output value of a door sensor used in a case of detecting getting off of a passenger (driver) in the parking assistance device according to the embodiment.

### DETAILED DESCRIPTION

Hereinafter, exemplary embodiments of the present disclosure are disclosed. The configurations of the embodiments described below, and the actions, results, and effects brought by the configurations are examples. The present disclosure can be realized by a configuration other than the configuration disclosed in the following embodiment, and at least one of various effects based on the basic configuration and derivative effects can be obtained.

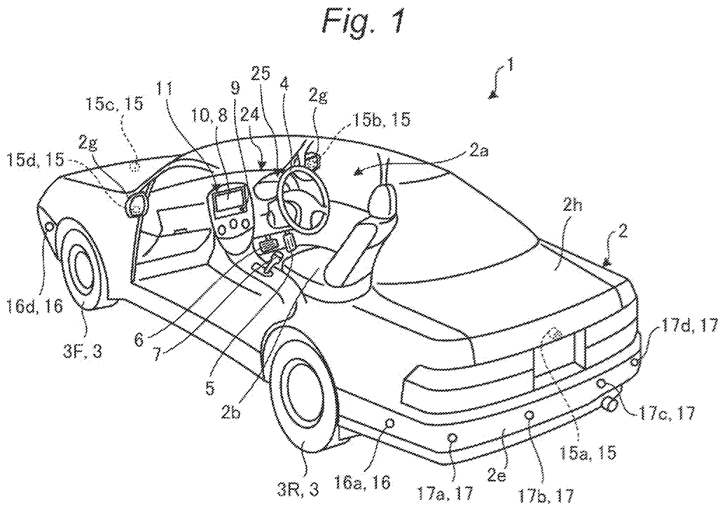

FIG. 1 is an exemplary schematic perspective view of a state in which a part of a vehicle interior 2a of a vehicle 1 equipped with a parking assistance device according to an embodiment is seen through. In the case of the parking assistance device of the present embodiment, the parking assistance control for automatically parking the vehicle 1 in the set parking area (parking space) can be executed without the driver performing the driving operation. Note that the parking assistance device of the present embodiment may execute the parking assistance control in a state where the passenger (fellow passenger) is on board, but basically, the parking assistance control is executed in a state where the passenger (driver or fellow passenger) is not on the vehicle 1.

First, a configuration of the vehicle 1 on which the parking assistance device of the present embodiment is mounted will be described.

The vehicle equipped with the parking assistance device according to the present embodiment may be an automobile (internal combustion engine automobile) using an internal combustion engine as a driving source, an automobile (electric vehicle, fuel cell vehicle, or the like) using an electric motor as a driving source, or an automobile (hybrid automobile) using both of them as driving sources. In addition, the vehicle can be equipped with various transmission devices, various devices (systems, components, or the like) necessary for driving the internal combustion engine and the electric motor. In addition, the type, number, layout, or the like of the device related to the driving of the wheels in the vehicle can be variously set.

As illustrated in FIG. 1, a vehicle body 2 of the vehicle 1 constitutes the vehicle interior 2a in which an occupant (passenger) (not illustrated) is on. In the vehicle interior 2a, a steering unit 4, an acceleration operation unit 5, a braking operation unit 6, a transmission operation unit 7, or the like are provided in a state of facing a seat 2b of a driver as an occupant. The steering unit 4 is, for example, a steering wheel protruding from a dashboard 24. The acceleration operation unit 5 is, for example, an accelerator pedal positioned at the feet of the driver. The braking operation unit 6 is, for example, a brake pedal positioned at the feet of the driver. The transmission operation unit 7 is, for example, a shift lever protruding from the center console.

In addition, in the vehicle interior 2a, a display device 8 (display unit) and a voice output device 9 as a voice output unit are provided. The display device 8 is, for example, a liquid crystal display (LCD), an organic electroluminescent display (OELD), or the like. The voice output device 9 is, for example, a speaker. In addition, the display device 8 is covered with a transparent operation input unit 10 such as a touch panel. The occupant (driver, fellow passenger) can visually recognize the image displayed on the display screen of the display device 8 via the operation input unit 10. In addition, the occupant can execute an operation input by touching, pushing, or moving the operation input unit 10 with a finger or the like at a position corresponding to an image displayed on the display screen of the display device 8. For example, in a case where the parking assistance control by the parking assistance device of the present embodiment is executed, an icon or the like for executing remote parking (mode to move vehicle 1 to parking area by automatic traveling after driver gets off vehicle 1) is displayed on the display device 8 before the driver gets off the vehicle, and the driver can be caused to input an intention confirmation for executing remote parking using the operation input unit 10. The display device 8, the voice output device 9, the operation input unit 10, or the like are provided in, for example, a monitor device 11 positioned at the center of a dashboard 24 in the vehicle width direction, that is, the left-right direction. The monitor device 11 can include an operation input unit (not illustrated) such as a switch, a dial, a joystick, and a push button. In addition, a voice output device (not illustrated) can be provided at another position in the vehicle interior 2a different from the monitor device 11, and voice can be output from the voice output device 9 of the monitor device 11 and another voice output device. In addition, a switch for executing remote parking may be provided separately from the monitor device 11. Note that the monitor device 11 can also be used as, for example, a navigation system or an audio system.

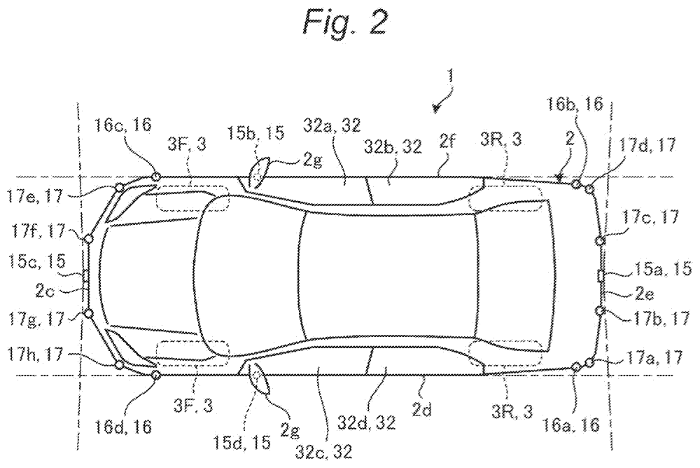

FIG. 2 is an exemplary schematic plan view of the vehicle 1 equipped with the parking assistance device according to the embodiment. As illustrated in FIGS. 1 and 2, the vehicle 1 is a four-wheeled automobile or the like, and includes two left and right front wheels 3F and two left and right rear wheels 3R. All or some of the four wheels 3 can be steered.

In the vehicle body 2, for example, four imaging units 15a to 15d are provided as a plurality of imaging units 15. The imaging unit 15 is, for example, a digital camera incorporating an imaging element such as a charge coupled device (CCD) or a CMOS image sensor (CIS). The imaging unit 15 can output moving image data at a predetermined frame rate. Each of the imaging units 15 includes a wide-angle lens or a fisheye lens, and can capture a range of, for example, 140° to 220° in the horizontal direction. In addition, the optical axis of the imaging unit 15 is set obliquely downward. Therefore, the imaging unit 15 sequentially captures an external environment around the vehicle body 2 including a road surface on which the vehicle 1 can move and an area where the vehicle 1 can be parked, and outputs the captured environment as captured image data.

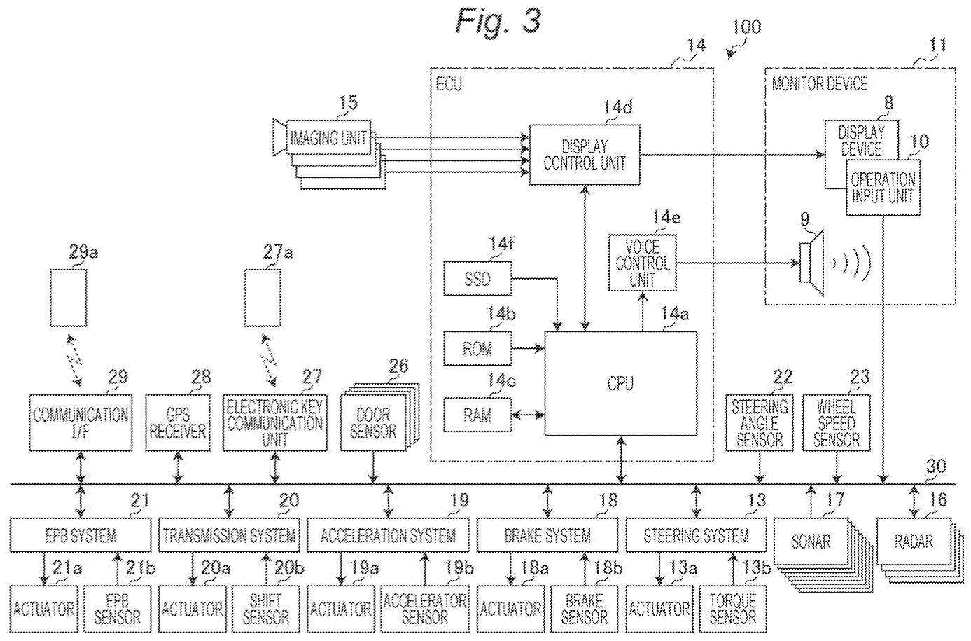

The imaging unit 15a is positioned at, for example, a rear end portion 2e of the vehicle body 2, is provided on a wall portion below a door 2h of the trunk, and images the situation of the rear area of the vehicle 1. The imaging unit 15b is positioned at, for example, a right end portion 2f of the vehicle body 2, is provided on a right door mirror 2g, and captures a situation of an area including the right front side, right side, and right rear of the vehicle 1. The imaging unit 15c is positioned, for example, at the front side of the vehicle body 2, that is, at an end portion 2c on the front side in the vehicle front-rear direction, is provided on the front bumper or the like, and images the situation of the front area of the vehicle 1. The imaging unit 15d is positioned, for example, on the left side of the vehicle body 2, that is, on the left end portion 2d in the vehicle width direction, is provided on the door mirror 2g as a left protruding portion, and images a situation of an area including the left front side, the left side, and the left rear side of the vehicle 1. An ECU 14 (see FIG. 3) constituting the parking assistance device can execute arithmetic processing and image processing based on the captured image data obtained by the plurality of imaging units 15 to generate an image with a wider viewing angle or generate a virtual overhead image of the vehicle 1 viewed from above (directly above or obliquely above).

In addition, the vehicle 1 includes a plurality of radars 16 as a distance measuring unit that can measure a distance to an object present outside the vehicle 1. The radar 16 is, for example, a millimeter wave radar or the like, and can measure a distance to an object present in a traveling direction of the vehicle 1 (a direction in which the vehicle 1 faces). In the present embodiment, the vehicle 1 includes a plurality of radars 16a to 16d. The radar 16a is provided, for example, at the left end portion of the rear bumper of the vehicle 1, and can measure a distance to an object present on the left rear side of the vehicle 1. In addition, the radar 16b is provided, for example, at the right end portion of the rear bumper of the vehicle 1, and can measure a distance to an object present on the right rear side of the vehicle 1. The radar 16c is provided, for example, at the right end portion of the front bumper of the vehicle 1, and can measure a distance to an object present on the right front side of the vehicle 1. In addition, the radar 16d is provided, for example, at the left end portion of the front bumper of the vehicle 1, and can measure a distance to an object present on the left front side of the vehicle 1.

In addition, the vehicle 1 includes a sonar 17 that can measure a distance to an external object present at a relatively short distance from the vehicle 1 using an ultrasonic wave. In the present embodiment, the vehicle 1 includes a plurality of sonars 17a to 17h. The sonars 17a to 17d are provided at the rear bumper of the vehicle 1, and can measure a distance to an object present on the rear side of the vehicle 1. The sonars 17e to 17h are provided at the front bumper of the vehicle 1, and can measure a distance to an object present on the front side of the vehicle 1.

FIG. 3 is an exemplary schematic block diagram illustrating a functional configuration of a control system 100 of the vehicle 1 including the parking assistance device according to the present embodiment. As illustrated in FIG. 3, in the control system 100, in addition to the ECU 14, the monitor device 11, the radar 16, the sonar 17, or the like, a steering system 13, a brake system 18, an acceleration system 19, a transmission system 20, an electromechanical parking brake (EPB) system 21, a steering angle sensor 22, a wheel speed sensor 23, a door sensor 26, an electronic key communication unit 27, a global positioning system (GPS) receiver 28, a communication interface (I/F) 29, or the like are electrically connected via an in-vehicle network 30 as an electric communication line. The in-vehicle network 30 is configured as, for example, a controller area network (CAN). The ECU 14 can control the steering system 13, the brake system 18, the acceleration system 19, the transmission system 20, the EPB system 21, or the like by sending a control signal through the in-vehicle network 30. In addition, the ECU 14 can acquire detection results of a torque sensor 13b, a brake sensor 18b, an accelerator sensor 19b, a shift sensor 20b, an EPB sensor 21b, the steering angle sensor 22, the wheel speed sensor 23, the radar 16, the sonar 17, the door sensor 26, or the like via the in-vehicle network 30. In addition, the ECU 14 can receive communication results of the electronic key communication unit 27, the GPS receiver 28, the communication interface 29, or the like, operation signals of switches such as the operation input unit 10, or the like via the in-vehicle network 30.

The steering system 13 is an electric power steering system, a steer by wire (SBW) system, or the like. The steering system 13 includes an actuator 13a and the torque sensor 13b. Then, the steering system 13 is electrically controlled by the ECU 14 or the like, and operates the actuator 13a to add torque to the steering unit 4 to supplement steering force, steering the wheels 3. The torque sensor 13b detects the torque applied to the steering unit 4 by the driver, and transmits the detection result to the ECU 14.

The brake system 18 includes an anti-lock brake system (ABS) that controls the locking of the brake of the vehicle 1, an electronic stability control (ESC) that suppresses the sideslip of the vehicle 1 at the time of cornering, an electric brake system that reinforces the braking force to assist the brake, and a brake by wire (BBW), in addition to the control of the braking force as the service brake. The brake system 18 includes an actuator 18a and the brake sensor 18b. The brake system 18 is electrically controlled by the ECU 14 or the like, and applies a braking force to the wheel 3 via the actuator 18a. The actuator 18a is, for example, a fluid pressure actuator that drives a carrier of a disc brake or a brake shoe of a drum brake at the time of pressurization to generate a braking force, operating a service brake that decelerates and brakes during traveling and maintains a stationary state at the time of stopping. That is, the brake system 18 functions as a first braking device that uses the actuator 18a to maintain the stop state (braking state). In addition, the brake system 18 detects a lock of the brake, idling of the wheel 3, a sign of the sideslip or the like from a rotation difference or the like of the left and right wheels 3, and executes control to suppress the lock of the brake, the idling of the wheel 3, and the sideslip. The brake sensor 18b is a displacement sensor that detects a position of a brake pedal as a movable portion of the braking operation unit 6, and transmits a detection result of the position of the brake pedal to the ECU 14.

The acceleration system 19 is an internal combustion engine system or a motor system as a driving source. The accelerator sensor 19b is a displacement sensor that detects a position of an accelerator pedal as a movable portion of the acceleration operation unit 5, and transmits the detection result to the ECU 14. The acceleration system 19 controls an actuator 19a according to the drivers required operation amount (for example, the depression amount of the accelerator pedal) detected by the accelerator sensor 19b, executes control of the fuel injection amount and the intake amount of the engine and control of the output value of the motor, and increases or decreases the speed of the vehicle 1.

The transmission system 20 drives an actuator 20a in accordance with the detection result detected by the shift sensor 20b, changes the gear meshing state, and controls the transmission ratio of the vehicle 1 and switches the forward traveling, the backward traveling, and the parking function. The shift sensor 20b is a sensor that detects the position of the movable portion (bars, arms, buttons, or the like) of the transmission operation unit 7, and transmits the detection result to the ECU 14. In addition, the transmission system 20 can control the transmission ratio or the like regardless of the operation position of the transmission operation unit 7 to obtain appropriate fuel consumption under the control of the ECU 14. Note that, in the transmission system 20, in a case where the shift position shifts to the parking P, a lock member (parking lock pole) is caught by a gear in a transmission, the gear is fixed, and the vehicle 1 is prevented from moving. That is, it functions as one of the braking devices that maintain the stopped state when the vehicle is stopped. In this case, the actuator 20a operates only when the lock member is caught by the gear, and functions as a second braking device that does not use the actuator 20a after the gear and the lock member are engaged.

Note that the ECU 14 cooperatively controls the steering system 13, the brake system 18, the acceleration system 19, the transmission system 20, or the like regardless of the drivers operation to execute steering control, braking control, output control of the engine and the motor, shift control, or the like, and can execute traveling assistance such as traveling assistance and parking assistance, for example.

The EPB system 21 is a system that generates a braking force by winding up a wire using an actuator 21a (for example, a motor) instead of a system that conventionally generates a braking force by a disc brake or a drum brake by pulling the wire by manual operation of a lever or a pedal. The ECU 14 controls the actuator 21a in response to, for example, an operation of an EPB switch disposed around the drivers seat, and winds up the wire to generate a braking force. In addition, the ECU 14 releases the winding of the wire to release the braking force in response to the operation of the release switch or the operation of the acceleration operation unit 5. The actuator 21a operates only when the wire is wound up, and functions as a second braking device that does not use the actuator 21a after winding in which the braking force is generated.

The steering angle sensor 22 is a sensor that detects a steering amount (steering angle) of the steering unit 4 such as a steering wheel. The steering angle sensor 22 includes a hall element or the like, detects the rotation angle of the rotating portion of the steering unit 4 as a steering amount, and transmits the detection result to the ECU 14. The ECU 14 (CPU 14a) may calculate the tire angle based on the acquired steering angle. In this case, for example, the calculation may be performed using a conversion map of the steering angle and the tire angle prepared in advance for each vehicle type, or may be performed based on a predetermined arithmetic expression. Note that, in another embodiment, a tire angle sensor may be provided in the steering mechanism to directly acquire the tire angle. The steering angle and the tire angle can be used, for example, in a case of searching for a movement route of the vehicle 1 when parking assistance or parking-slot-exiting assistance of the vehicle 1 is performed or in a case of actually automatically traveling the vehicle 1.

The wheel speed sensor 23 is a sensor that is provided on each wheel 3 and detects the rotation amount of each wheel 3 and the rotation speed per unit time, and outputs the number of wheel speed pulses indicating the detected rotation speed as a detection value. The wheel speed sensor 23 can include, for example, a hall element or the like. The ECU 14 calculates a vehicle speed, a movement amount, or the like of the vehicle 1 based on the detection value acquired from the wheel speed sensor 23, and executes various controls. In a case where calculating the vehicle speed of the vehicle 1 based on the detection value of the wheel speed sensor 23 of each wheel 3, the ECU 14 determines the vehicle speed of the vehicle 1 based on, for example, the speed of the wheel 3 having the smallest detection value among the four wheels, and executes various controls. In addition, in a case where a wheel 3 having a larger detection value than other wheels 3 among the four wheels is present, for example, in a case where there is a wheel 3 having a larger number of rotations per unit period (unit time or unit distance) than other wheels 3 by a predetermined number or more, the ECU 14 regards that the wheel 3 is in a slip state (wheelspin state) and executes various controls. The wheel speed sensor 23 may be provided in the brake system 18. In this case, the ECU 14 acquires the detection result of the wheel speed sensor 23 via the brake system 18.

The door sensor 26 is a sensor that is provided on each of doors 32 (32a to 32d) for getting on and off the vehicle 1 illustrated in FIG. 2, the door 2h (the door of the trunk), and the back door of the vehicle in a case where the back door is present, and detects whether the door is opened or closed for each door 32 or the like, and transmits the detection result to the ECU 14. The door sensor 26 may be a contact type mechanical switch, a non-contact type photoelectric sensor, a capacitance sensor, or the like. The ECU 14 may determine that the occupant (passenger) has got on and off when the door sensor 26 detects the closing operation following the opening operation of the door 32. Note that, in the case of the door 2h of the trunk where the occupant does not get on and off as in the vehicle 1 illustrated in FIG. 1, the door sensor 26 disposed in the door 2h is used for the determination of opening and closing of the trunk and is not used for the determination of getting on and off. On the other hand, depending on the vehicle type, there is a vehicle that allows the occupant (passenger) to get on and off through a back door. In this case, it may be determined that the occupant (passenger) gets on and off based on the opening and closing operation of the back door.

The electronic key communication unit 27 constantly transmits a weak radio wave around the vehicle 1 (for example, a predetermined range of several meters) to detect (search for) an electronic key 27a as a detection target. In a case where the electronic key 27a is detected within the predetermined range, authentication information (authentication ID) transmitted from the electronic key 27a is received and transmitted to the ECU 14. The ECU 14 collates the authentication information transmitted from the electronic key with the reference authentication information set in advance on the vehicle 1 side, and in a case where the authentication is affirmed, the ECU 14 permits control of locking and unlocking the door 32 of the vehicle 1, reception of an ignition switch operation, or the like. The ECU 14 can determine whether the electronic key 27a is present inside the vehicle interior 2a of the vehicle 1 or outside the vehicle interior 2a (outside the vehicle) based on the detection position of the electronic key 27a in the range of the weak radio wave transmitted by the electronic key communication unit 27, and can execute control of the vehicle 1 based on the position of the electronic key 27a.

The GPS receiver 28 acquires the current position of the vehicle 1 based on the radio wave received from the artificial satellite. For example, when the traveling assistance control, the parking assistance control, or the like are executed, the guidance control can be executed based on the current position of the vehicle 1, and based on the acquisition of the movement route, the movement route, and the current position of the vehicle 1. Note that, in a case where the vehicle 1 is equipped with a navigation system, GPS information (information on the current position of the vehicle 1) may be acquired from the navigation system. In this case, the GPS receiver 28 may be omitted.

The communication interface 29 is an interface that realizes communication between the control system 100 (parking assistance device) of the vehicle 1 and an external device. For example, the communication interface 29 realizes transmission and reception of a signal by wireless communication between the ECU 14 the terminal device 29a carried by the occupant (passenger). Note that the terminal device 29a may be, for example, a dedicated terminal device for executing the parking assistance of the present embodiment, or may be integrated with the electronic key 27a that drives the vehicle 1. In addition, it may be a portable terminal such as a tablet or a smartphone in which a dedicated application is installed.

Note that the configurations, arrangements, electrical connection forms, or the like of the various systems, sensors, actuators, or the like described above are merely examples, and can be variously set (changed).

The ECU 14 is constituted by a computer or the like, and performs overall control of the vehicle 1 by cooperation of hardware and software. Specifically, the ECU 14 includes a central processing unit (CPU) 14a, a read only memory (ROM) 14b, a random access memory (RAM) 14c, a display control unit 14d, a voice control unit 14e, and a solid state drive (SSD) 14f. The CPU 14a, the ROM 14b, and the RAM 14c may be provided in the same circuit board.

The CPU 14a can read a program installed and stored in a nonvolatile storage device such as the ROM 14b and execute arithmetic processing according to the program. The CPU 14a can execute, for example, calculation and control related to parking assistance control, or the like. In addition, the CPU 14a can execute a distortion correction processing of correcting distortion by applying arithmetic processing or image processing to the captured image data (data of a curved image) of the wide-angle image obtained by the imaging unit 15, or can generate an overhead image (peripheral image) displaying a vehicle image (host vehicle icon) indicating the vehicle 1 at a center position, for example, based on the captured image data captured by the imaging unit 15 and display the overhead image on the display device 8. In addition, when generating the overhead image, the CPU 14a can change the position of the virtual viewpoint and generate an overhead image that faces the vehicle image from directly above or an overhead image that faces the vehicle image from an oblique direction.

For example, in a case of performing traveling assistance such as parking assistance, the CPU 14a may generate an image that allows the passenger (driver) to easily recognize the situation of parking assistance or the surrounding situation of the vehicle 1 at the time of parking assistance from the outside of the vehicle, and transmit the image to the terminal device 29a carried by the driver via the communication interface 29 in a manner that the driver can confirm the image. Note that traveling assistance such as parking assistance may also be executed when the passenger is present in the vehicle. In this case, the image indicating the situation of parking assistance or the like may be displayed on the display device 8.

The ROM 14b stores various programs, parameters necessary for executing the programs, or the like. The RAM 14c temporarily stores various data used in the calculation in the CPU 14a. Among the arithmetic processing in the ECU 14, the display control unit 14d mainly executes image processing on image data acquired from the imaging unit 15 and output to the CPU 14a, conversion of the image data acquired from the CPU 14a into image data for display to be displayed on the display device 8, or the like. Among the arithmetic processing in the ECU 14, the voice control unit 14e mainly executes processing of voice acquired from the CPU 14a and output to the voice output device 9. The SSD 14f is a rewritable nonvolatile storage unit, and continues to store data acquired from the CPU 14a even in a case where the power source of the ECU 14 is turned off. Note that the CPU 14a, the ROM 14b, the RAM 14c, or the like can be integrated in the same package. In addition, the ECU 14 may have a configuration in which another logical operation processor such as a digital signal processor (DSP), a logic circuit, or the like is used instead of the CPU 14a. In addition, a hard disk drive (HDD) may be provided instead of the SSD 14f, and the SSD 14f and the HDD may be provided separately from the ECU 14.

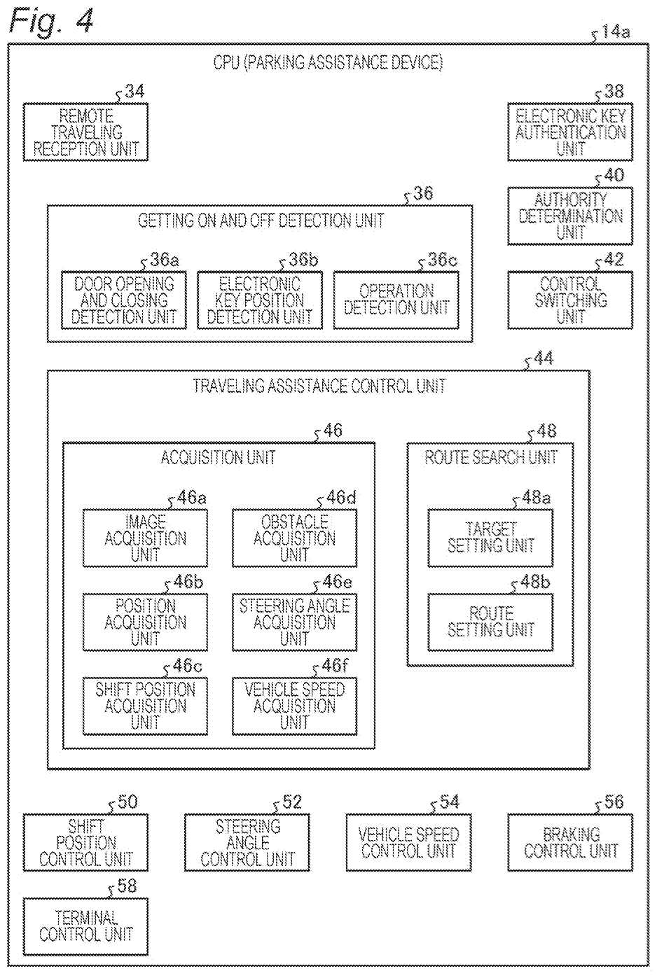

FIG. 4 is a block diagram exemplarily and schematically illustrating a configuration in a case where the parking assistance device according to the embodiment is realized by the CPU 14a. The CPU 14a executes the parking assistance processing program read from the ROM 14b, realizing modules such as a remote traveling reception unit 34, a getting on and off detection unit 36, an electronic key authentication unit 38, an authority determination unit 40, a braking switching unit 42, and a traveling assistance control unit 44 as illustrated in FIG. 4.

In the case of the parking assistance device of the present embodiment, as described above, the parking assistance control (remote traveling control) for automatically parking the vehicle 1 in the set parking area can be executed without the driver performing the driving operation. In this case, before getting off the vehicle 1, the driver outputs an operation signal for shifting to a state where parking assistance control by automatic control can be executed, for example, by operating the operation input unit 10. In a case where receiving the operation signal provided from the operation input unit 10, the remote traveling reception unit 34 shifts the parking assistance device (CPU 14a) to a state in which parking assistance control can be performed. Note that the remote traveling reception unit 34 can also receive, as the remote traveling request input from the terminal device 29a via the communication interface 29, a request for parking-slot-exiting assistance control for moving from a parking state to a predetermined place where the driver or the like waits by automatic traveling, in addition to the automatic parking control by the parking assistance control.

In the case of the parking assistance device of the present embodiment, as described above, the parking assistance device may execute the parking assistance and the parking-slot-exiting assistance in a state where the passenger (driver) is on the vehicle 1, but basically, the parking assistance or the like are executed in a state where the passenger (driver) is not on board the vehicle 1. Therefore, it is necessary to detect whether the passenger (driver) is present in the vehicle 1 and the position of the passenger (driver). Therefore, the getting on and off detection unit 36 includes detailed modules such as a door opening and closing detection unit 36a, an electronic key position detection unit 36b, and an operation detection unit 36c.

The door opening and closing detection unit 36a acquires an opening and closing signal output from the door sensor 26. For example, the door sensor 26 outputs an ON signal in a case where the door 32 is fully closed, and is turned off when the door 32 is opened by a predetermined angle or more. Therefore, the opening and closing operation of the door 32 can be detected by referring to the transition of the output value (signal value) of the door sensor 26. For example, in a case where the door 32 shifts from the closed state to the open state, the opening of the vehicle body 2 is once released, and then in case where the door shifts to the closed state, it can be estimated that the open door 32 is closed. That is, the method can be used as a method of estimating whether or not the passenger has got on or off. Note that, as described above, in the case of a vehicle of a type that allows getting on and off from a back door, the door opening and closing detection unit 36a may acquire an opening and closing signal from the door sensor 26 provided in the back door. In this case, whether or not the occupant gets on or off may be estimated based on the opening and closing operation of the back door.

The electronic key position detection unit 36b detects the position of the electronic key 27a that allows traveling control of the vehicle 1. As described above, the electronic key 27a functions as an ignition key that allows the engine, electronic equipment, or the like of the vehicle 1 to start. The electronic key position detection unit 36b can determine whether the electronic key 27a is present inside the vehicle interior 2a of the vehicle 1 or outside the vehicle interior 2a based on the position of the electronic key 27a in the transmission range of the weak radio wave transmitted by the electronic key communication unit 27. That is, in a case where the strength of the signal from the electronic key 27a is equal to or greater than the predetermined threshold value, it can be estimated that the electronic key 27a is present in the vehicle interior 2a, and it can be regarded that the passenger (driver) of the vehicle 1 is in the vehicle 1. On the other hand, in a case where the strength of the signal from the electronic key 27a is less than the predetermined threshold value, it can be estimated that the electronic key 27a is present outside the vehicle interior 2a, and it can be regarded that the passenger (driver) of the vehicle 1 has got off the vehicle 1. That is, the method can be used as another method of estimating whether or not the passenger has got on or off. Note that, since there may be a plurality of electronic keys 27a, it is desirable to determine whether the passenger gets on or off by combining the position information where the electronic key 27a is present and other information.

In a case where the passenger sits on the seat 2b (drivers seat), the operation detection unit 36c detects whether or not the operable driving operation unit has been operated. The driving operation unit is, for example, the steering unit 4 (steering wheel), the acceleration operation unit 5 (accelerator pedal), the braking operation unit 6 (brake pedal), the transmission operation unit 7 (shift lever), or the like, and may output an operation detection signal in a case where being actually operated, or may output an operation detection signal when the driving operation unit is touched (has become in an operable state). Note that the driving operation unit is not limited to the above-described example, and may output the operation detection signal even in a case where the driving operation unit touches or operates the monitor device 11 or the air conditioner. In addition, when seating on the seat 2b is detected by a weight sensor, a pressure sensor, or the like, an operation detection signal may be output.

Note that, in a case where the getting on and off detection unit 36 determines that the passenger has got off the vehicle only by the door 32 changing from the closed state to the open state first and then to the closed state again by the door opening and closing detection unit 36a, there is an advantage that it is easy to avoid ambiguity of the determination in a case where a plurality of electronic keys 27a and terminal devices 29a is present. In addition, in another embodiment, although there is one electronic key 27a and one terminal device 29a, the determination accuracy can be improved by referring to the current position of the electronic key 27a by the electronic key position detection unit 36b and determining that the passenger (driver) has got off the vehicle in addition to the condition that the electronic key 27a is present outside the vehicle.

On the other hand, the getting on and off detection unit 36 may determine that the passenger has got on the vehicle when the electronic key position detection unit 36b causes the passenger to exist in the vehicle interior 2a and the operation detection unit 36c operates the driving operation unit. By considering the detection result by the electronic key position detection unit 36b at the time of getting on, it is possible to clearly distinguish between getting on and off. Note that the condition that the door 32 of the drivers seat is changed from the closed state to the open state and is further changed to the closed state may be added in a case where it is determined that the driver has got on the vehicle. In this case, more reliable getting on stability can be achieved.

The electronic key authentication unit 38 compares the authentication information of the electronic key 27a acquired by the electronic key communication unit 27 with preset reference authentication information of the vehicle 1, and in a case where the mutual authentication information matches and the authentication is established, provides authentication affirmation information to each control unit of the vehicle 1 to enable control of each control unit. For example, it is possible to control each control system that controls the electrical system of the vehicle 1, including a door system, an ignition system, or the like that controls locking and unlocking of the door 32. Therefore, in a case where the authentication by the electronic key authentication unit 38 is not established, each control system of the vehicle 1 maintains the current state.

The authority determination unit 40 determines whether the traveling control authority of the vehicle 1 is attributed to the traveling assistance control unit 44 or the passenger (driver) based on the detection result of the getting on and off detection unit 36.

For example, the authority determination unit 40 determines that the passenger (driver) has got off the vehicle in a case where the closing operation is detected as the getting on and off action by the door opening and closing detection unit 36a following the opening operation of the door 32 of the drivers seat in the getting on and off detection unit 36 in a state where the traveling control authority is attributed to the driver. Then, the authority determination unit 40 determines to transfer the traveling control authority from the passenger (driver) to the traveling assistance control unit 44. That is, the vehicle 1 is shifted to a state where the vehicle 1 can be automatically driven without intervention of the driver. Note that, in the present embodiment, the automatic driving after the passenger (driver) gets off the vehicle is parking assistance driving in which the vehicle 1 is moved to a predetermined parking area to complete parking. In a case where the parking assistance operation is performed, it is basically assumed that all passengers in the vehicle interior 2a have got off the vehicle. For example, in a case where the driver operates the terminal device 29a or the like to execute the parking assistance control after getting off the vehicle, a message for confirming that there is no passenger in the vehicle interior 2a may be output to the terminal device 29a by display or voice to call attention. In addition, the authority determination unit 40 may output a message indicating that the traveling control authority has been transferred to the traveling assistance control unit 44 to the terminal device 29a by display or voice.

In addition, in a case where it is detected that the terminal device 29a that can activate the parking-slot-exiting assistance control is present in the vehicle interior 2a, and an operation of the driving operation unit in the driver's seat is detected as a getting on and off action with respect to the vehicle 1, the authority determination unit 40 determines that the passenger (driver) has got on the vehicle after parking-slot-exiting. Then, the authority determination unit 40 determines to transfer the traveling control authority from the traveling assistance control unit 44 to the passenger (driver). That is, the vehicle 1 is shifted to a state in which manual driving by the driver is possible without intervention of the traveling assistance control unit 44. In this case, whether or not the terminal device 29a is present in the vehicle interior 2a can be estimated by the position where the electronic key 27a is present. For example, in a case where the electronic key position detection unit 36b detects that the electronic key 27a is present in the vehicle interior 2a, it can be regarded that the terminal device 29a carried by the driver is also present in the vehicle interior 2a. Note that, in a case where the terminal device 29a is integrated with the electronic key 27a, the detection result of the electronic key position detection unit 36b may be used as information for determining that the passenger (driver) has got on the vehicle after parking-slot-exiting.

The braking switching unit 42 controls the brake system 18, the transmission system 20, the EPB system 21, or the like to switch the application state of the braking force to the vehicle 1. In the present embodiment, in a case where the parking assistance control is executed, the engine and the motor which are the traveling driving source of the vehicle 1 are stopped in the driving state, and the driver gets off the vehicle. Therefore, it is desirable to generate the control force when the driver gets off the vehicle 1 and until the driver starts to move according to at least the movement route after getting off the vehicle 1. On the other hand, if the actuator or the like is kept driven when the vehicle 1 stops, the energy efficiency decreases.

Therefore, in the case of the parking assistance device of the present embodiment, in order for the driver to execute the parking assistance control, in a case where the remote traveling reception unit 34 receives the remote traveling request signal from a state where the vehicle 1 is stopped by generating the braking force (braking force by the service brake) by depressing the braking operation unit 6, first, the actuator 18a of the brake system 18 is controlled to automatically generate the braking force by the service brake. In addition, the actuator 20a of the transmission system 20 is controlled to generate the braking force by the engagement between the gear and the lock member. Furthermore, the actuator 21a of the EPB system 21 is controlled to generate the braking force by the EPB. As described above, the braking force by the transmission system 20 drives the actuator 20a only in a case where the operation of engaging the gear and the lock member is performed, and the braking force can be maintained even if the supply of the current is stopped after the engagement (after the generation of the braking force). Similarly, the EPB also drives the actuator 21a only at the time of winding the wire, and can maintain the braking force even if the supply of the current is stopped after winding (after the generation of the braking force). On the other hand, a service brake such as a disc brake or a drum brake needs to continuously supply a current to the actuator 18a in order to maintain the generation of the braking force.

Therefore, in a case where it has been confirmed that the braking force is sufficiently secured, the braking switching unit 42 switches the braking control to stop using the brake system 18 (service brake system: first braking device) that requires electric power to generate the braking force. In this case, when the actuator 18a is instantaneously non-driven, a shock (vibration, abnormal noise, or the like) due to release of the braking force may occur. Therefore, the braking switching unit 42 may perform gradual change control to gradually release the braking force with respect to the brake system 18. By not using the brake system 18 as the first braking device, it is possible to reliably guarantee the stop of the vehicle 1 in the period until the driver releases the depression of the braking operation unit 6, gets off the vehicle 1, and leaves and starts traveling by the parking assistance control. In addition, at that time, it is possible to contribute to reduction (elimination) of a load on the actuator 18a (brake system 18) and energy saving.

Next, a configuration of the traveling assistance control unit 44 will be described.

The traveling assistance control unit 44 includes an acquisition unit 46, a route search unit 48, a shift position control unit 50, a steering angle control unit 52, a vehicle speed control unit 54, a braking control unit 56, a terminal control unit 58, or the like as modules for executing the parking assistance control and the parking-slot-exiting assistance control. Note that the acquisition unit 46 includes detailed modules such as an image acquisition unit 46a, a position acquisition unit 46b, a shift position acquisition unit 46c, an obstacle acquisition unit 46d, a steering angle acquisition unit 46e, and a vehicle speed acquisition unit 46f. In addition, the route search unit 48 includes a target setting unit 48a and a route setting unit 48b.

The acquisition unit 46 acquires various types of information necessary for the parking assistance control and the parking-slot-exiting assistance control.

The image acquisition unit 46a acquires peripheral images of the vehicle 1 captured by the imaging unit 15 while the vehicle 1 is traveling and stopped. The acquired image information can be used for searching for a parking area candidate in which the vehicle 1 can be parked, detecting an object that may come into contact with the vehicle 1 while moving to a target parking area selected from the surroundings of the vehicle 1 and the parking area candidate, searching for a movement route for moving to the target parking area, or the like.

The position acquisition unit 46b acquires the current position (absolute coordinates) of the vehicle 1 based on the GPS signal acquired from the GPS receiver 28, and is used for searching for a movement route, confirming a movement state, or the like. Note that the position acquisition unit 46b may estimate the current position (relative position) of the vehicle 1 with respect to the reference position based on, for example, the image information acquired by the image acquisition unit 46a and the movement distance, the movement direction, or the like from the reference position specified by the image information in addition to the position acquisition based on the GPS signal. That is, when the reference position is determined and the target parking area is determined, the position of the vehicle 1 between the two points can be estimated even in a case where the GPS signal cannot be received.

The shift position acquisition unit 46c acquires the current shift position of the vehicle 1 based on a signal from the shift sensor 20b of the transmission system 20. Based on the shift position, the traveling assistance control unit 44 can determine whether the current vehicle 1 can travel forward, can travel backward, or is in a parking state (braking state).

The obstacle acquisition unit 46d acquires a position of an object present around the vehicle 1, in particular, an obstacle that may come in contact with the vehicle 1 when the vehicle 1 travels, using a known technique based on the image information acquired by the imaging unit 15 and the reflected wave information acquired by the radar 16 and the sonar 17. Note that the obstacle acquisition unit 46d may identify, for example, another vehicle, a bicycle, a pedestrian, a stationary object such as a wall or a column, or the like as the type of the object detected by pattern recognition or the like.

The steering angle acquisition unit 46e acquires the current steering angle of the vehicle 1 based on the rotation angle acquired from the steering angle sensor 22. The acquired steering angle can be used to determine the traveling direction of the vehicle 1 at the time of the parking assistance control or the parking-slot-exiting assistance control.

The vehicle speed acquisition unit 46f estimates the vehicle speed of the vehicle 1 based on the detection value acquired by the wheel speed sensor 23. The vehicle speed of the vehicle 1 can be used to realize the optimum movement by being reflected in the control of the steering system 13, the brake system 18, the acceleration system 19, the transmission system 20, or the like at the time of the parking assistance control and the parking-slot-exiting assistance control.

The route search unit 48 searches for a movement route when the parking assistance control or the parking-slot-exiting assistance control is executed based on the various types of information acquired by the acquisition unit 46. A known technique can be used to search for a movement route.

The target setting unit 48a detects and sets an area where the vehicle 1 can be parked based on the image information captured by the imaging unit 15. The target setting unit 48a searches for and sets a parking area candidate that the vehicle 1 can enter based on specifications such as a vehicle width, a vehicle length, and a turning radius of the vehicle 1. The target setting unit 48a may detect a parking area candidate from image information captured by the imaging unit 15 when the vehicle 1 is traveling to park, or may detect a parking area candidate using a map or the like indicating a usage status of a parking lot acquired via the communication interface 29. The target setting unit 48a may output and set a single recommended parking area as a parking area candidate, or may provide a plurality of parking area candidates to the driver and cause the driver to select a desired parking area. Note that, in the case of the parking-slot-exiting assistance control, the target setting unit 48a sets the parking-slot-exiting position designated by the driver or the like or a preset parking-slot-exiting position as the parking-slot-exiting target position.

The route setting unit 48b sets a movement route when the parking assistance control for moving from the current position of the vehicle 1 to the parking area set by the target setting unit 48a is executed. Similarly in the case of the parking-slot-exiting assistance control, a movement route for moving from the current position of the vehicle 1 (parking area during parking) to the parking-slot-exiting target position set by the target setting unit 48a is set. Note that the route setting unit 48b may present a single route candidate as a set route, or may present a plurality of route candidates and cause the driver to select and set the route candidates.

Based on the current shift position of the vehicle 1 acquired by the shift position acquisition unit 46c, the shift position control unit 50 controls the actuator 20a of the transmission system 20 based on the parking target position or the parking-slot-exiting target position set by the target setting unit 48a, the movement route set by the route setting unit 48b, or the like to be a shift position (a shift position during forward traveling or a shift position during backward traveling) optimum for movement assistance.

Similarly, the steering angle control unit 52 controls the actuator 13a of the steering system 13 in a manner that the vehicle 1 can move according to the movement route set by the route setting unit 48b. In addition, the vehicle speed control unit 54 also controls the actuator 19a of the acceleration system 19 in a manner that the vehicle 1 can move safely according to the movement route set by the route setting unit 48b.

In addition, the braking control unit 56 also controls the actuator 18a of the brake system 18 in a manner that the vehicle speed of the vehicle 1 allows safe movement according to the movement route set by the route setting unit 48b. Note that the braking control unit 56 performs control of the EPB system 21 and braking control in a case where the transmission system 20 functions as a braking device at the parking position in accordance with the state of the vehicle 1.

The terminal control unit 58 performs, on the terminal device 29a via the communication interface 29, information to be provided to the passenger (driver), for example, guidance display such as safety confirming around the vehicle 1 or a getting on instruction, or a voice instruction in accordance with the current control state of the vehicle 1.

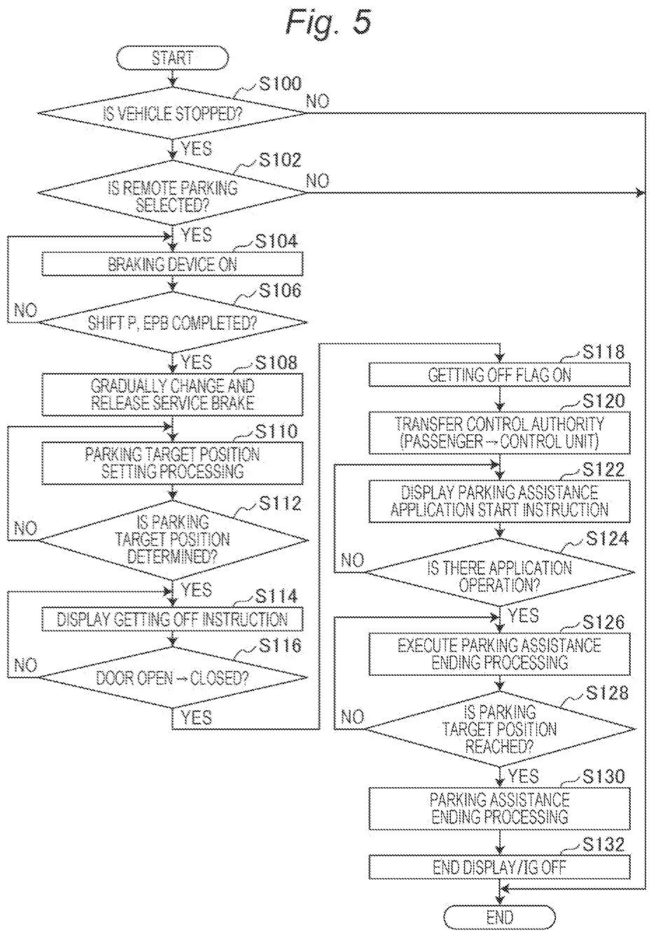

A flow of parking assistance control in the parking assistance device configured as described above will be described with reference to FIGS. 5 to 7.

FIG. 5 is an exemplary flowchart illustrating a flow of processing in a case where the parking assistance device confirms getting off of a passenger (driver), performs control transfer, and executes parking assistance control. Note that in a case where the parking assistance control is executed after the driver gets off the vehicle, it is assumed that the engine remains started.

The parking assistance device (CPU 14a) first confirms whether or not the vehicle 1 is stopped based on the wheel speed information from the vehicle speed acquisition unit 46f (S100). In a case where the vehicle 1 is not stopped (No in S100), that is, in a case where the vehicle 1 is traveling, this flow is temporarily ended. In a case where the vehicle 1 is stopped (Yes in S100), that is, in a case where the driver depresses the braking operation unit 6 (brake pedal), braking force by the brake system 18 (service brake) is generated. In this case, it is confirmed whether or not the remote traveling reception unit 34 receives a signal indicating that remote parking is selected by operating a switch such as the operation input unit 10 installed in the vehicle interior 2a (S102). In a case where remote parking is not selected by the driver (No in S102), this flow is temporarily ended.

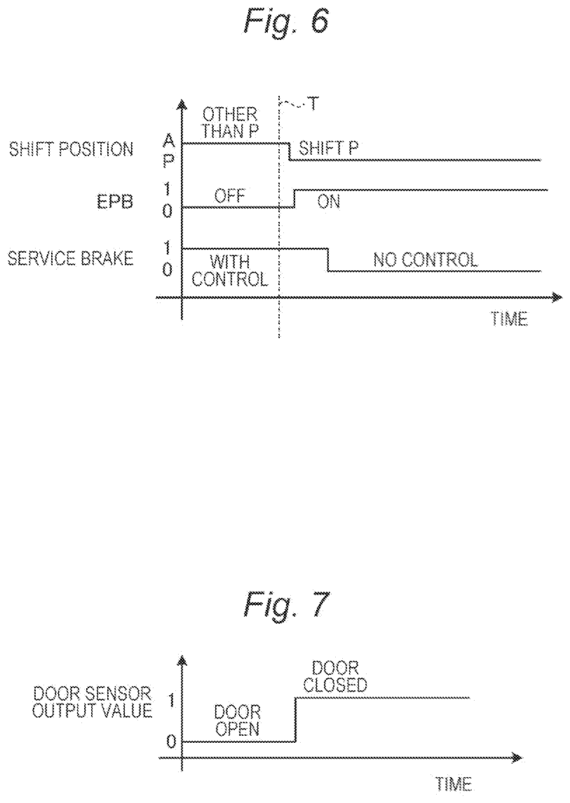

On the other hand, in a case where remote parking is selected by the driver (Yes in S102: timing T), the braking control unit 56 generates braking force by an auxiliary braking device (auxiliary brake) in addition to braking force by the service brake before executing remote parking (parking assistance control) (S104). That is, as illustrated in FIG. 6, in addition to the service brake, the transmission system 20 is controlled to generate the braking force (braking force generating state). As described above, when the shift position is shifted from a position other than the position of the parking (P) (A: Any) to the parking (shift P) in the transmission system 20, the gear in the transmission is locked and the braking force is generated. In addition, the braking control unit 56 controls the EPB system 21 to generate a braking force by the EPB (signal 0→signal 1). Note that, in a case where remote parking is selected (timing T), the braking control unit 56 controls the actuator 18a of the brake system 18 to maintain the generation of the braking force by the service brake regardless of whether the operation of the braking operation unit 6 by the driver is present (maintain signal 1).

Next, the braking switching unit 42 confirms whether or not the generation of the braking force (shift P) by the engagement between the gear of the transmission system 20 and the lock member and the braking force by the EPB brake by the EPB system 21 is completed (S106). For example, in the determination based on the signals from the shift sensor 20b and the EPB sensor 21b, in a case where it cannot be confirmed that the generation of the braking force by the auxiliary brake (shift P, EPB) is completed (No in S106), the processing proceeds to S104, and the generation control processing of the braking force by the auxiliary brake is continued. On the other hand, in a case where it is confirmed that the generation of the braking force by the auxiliary brake (shift P, EPB) is completed (Yes in S106), the braking switching unit 42 gradually changes and releases the generation of the braking force by the brake system 18 (S108). As described above, the brake system 18 is a first braking device that uses the actuator 18a to maintain the stop state (braking state). That is, the actuator 18a is in the driving state while the braking force is being generated. On the other hand, the transmission system 20 is a second braking device in which the actuator 20a is driven only when the gear and the lock member are engaged, and the actuator 20a is not used after the engagement in which the braking force is generated by the engagement between the gear and the lock member. Similarly, the EPB system 21 is a second braking device that drives the actuator 21a only during winding of the wire and does not use the actuator 21a after winding in which the braking force is generated. Therefore, after the braking force by the auxiliary brake (shift P, EPB) is secured, by releasing the service brake, it is possible to contribute to energy saving by not using the actuator 18a (braking force non-generating state of the first braking device) after securing the sufficient braking force when the passenger (driver) gets off the vehicle and before and after that.

Next, a parking target position setting processing is performed by the target setting unit 48a (S110). Note that, in a case where the target setting unit 48a sets the parking target position, the target setting unit 48a desirably displays the parking target position (candidate) on the display device 8 or the like, receives approval from the driver, and determines the parking target position (S112). In a case where the parking target position has not been determined (No in S112), the parking target position setting processing in S110 is continued. For example, other candidates for the parking target position are presented. On the other hand, in a case where the parking target position has been determined (Yes in S112), the display control unit 14d uses the display device 8 to display a getting off instruction to the driver (S114). Note that voice guidance using the voice output device 9 may be performed in addition to or instead of the getting off instruction display using the display device 8. In this case, since the braking force by the auxiliary brake (shift P, EPB) is secured, the vehicle 1 does not start to move, and the passenger (driver or the like) can get off safely.

After the getting off instruction display is performed, as illustrated in FIG. 7, in a case where the door opening and closing detection unit 36a shifts the door 32 of the drivers seat in the closed state to the open state, and further shifts the door to the closed state (Yes in S116: signal 0→signal 1), it is estimated that the driver has got off the vehicle, and the getting on and off detection unit 36 turns on the getting off flag (S118). In a case where the getting off flag is turned on, the authority determination unit 40 determines that the requirement for executing the parking assistance control is satisfied, and shifts the control authority from the passenger (driver) to the traveling assistance control unit 44 (S120). Note that, in a case where the closing operation subsequent to the opening operation of the door 32 of the drivers seat has not been confirmed in S116 (No in S116), the processing returns to S114 to continue the getting off instruction display.

In a case where the control authority is transferred to the traveling assistance control unit 44 in S120, the authority determination unit 40 displays a start instruction of a dedicated application for parking assistance (parking assistance application) on the terminal device 29a or the like carried by the passenger (driver) (S122). In a case where the remote traveling reception unit 34 acquires the operation of the dedicated application for parking assistance, for example, the operation of parking assistance start from the terminal device 29a (Yes in S124), the traveling assistance control unit 44 sets the parking target position and the movement route as described above, and executes the parking assistance processing by cooperation of the shift position control unit 50, the steering angle control unit 52, the vehicle speed control unit 54, the braking control unit 56, or the like (S126). Note that, in a case where the operation of the dedicated application cannot be confirmed in S124 (No in S124), the processing returns to S122 to continuously display an instruction to start the dedicated application for parking assistance, an instruction input request, or the like.

After execution of the parking assistance processing, the traveling assistance control unit 44 confirms whether the current position of the vehicle 1 has reached the parking target position set by the position acquisition unit 46b (S128). In a case where the current position of the vehicle 1 has reached the parking target position (Yes in S128), the traveling assistance control unit 44 executes parking assistance ending processing (S130). For example, the braking control unit 56 controls the transmission system 20 via the shift position control unit 50, shifts the shift position to the parking position (shift P), and generates the braking force by fixing the gear. In addition, the braking control unit 56 controls the EPB system 21 to generate a braking force by the EPB brake. Then, the authority determination unit 40 causes the terminal device 29a or the like to perform end display or end announcement indicating that parking assistance has ended, and turns off the ignition switch of the vehicle 1 to bring the vehicle 1 into a rest state, and ends this flow (S132). Note that, in a case where the vehicle 1 has not yet reached the parking target position in S128 (No in S128), the processing returns to S126 to continue the parking assistance processing. That is, the movement of the vehicle 1 is continued based on the movement route. In addition, in a case where a new obstacle or the like is found on the movement route while the vehicle 1 is moving, the movement route may be searched again, and the parking assistance control may be continued. In addition, in another embodiment, in a case where an obstacle is present at a position where the obstacle cannot be avoided, the traveling assistance control unit 44 may determine that continuation of the parking assistance control is inappropriate, notify the driver of cancellation of the parking assistance control via the terminal device 29a, and request the driver to take action.

As described above, according to the parking assistance device of the present embodiment, for example, after the braking force by the second braking device (transmission system 20, EPB system 21) that does not use the actuator for maintaining the stop state is secured, the first braking device (brake system 18) that uses the actuator for maintaining the stop state is not driven. As a result, it is possible to contribute to reduction of the load of the actuator 18a and energy saving of the system while reliably securing the braking force when the passenger gets off the vehicle.

Note that the program for the parking assistance processing executed by the CPU 14a that realizes the parking assistance device according to the present embodiment may be provided by being recorded in a computer-readable recording medium such as a CD-ROM, a flexible disk (FD), a CD-R, or a digital versatile disk (DVD) as a file in an installable format or an executable format.

Furthermore, the program for executing the processing of the present embodiment may be stored on a computer connected to a network such as the Internet and provided by being downloaded via the network. In addition, the program executed in the present embodiment may be provided or distributed via a network such as the Internet.

A parking assistance device includes: a traveling assistance control unit that causes a vehicle to automatically travel to a designated parking area and park the vehicle; a reception unit that receives an operation signal for shifting to a state in which traveling control by the traveling assistance control unit can be executed from an operation unit provided in a vehicle interior of the vehicle; and a braking switching unit that switches a braking device that maintains a stop state of the vehicle to a braking force generating state in a case where the operation signal is received.

According to this configuration, for example, when the passenger (for example, the driver) performs an operation to make the traveling control by the traveling assistance control unit executable in the vehicle interior, the state is switched to the braking force generating state for maintaining the stop state of the vehicle. As a result, in a case where the parking assistance control is executed, the braking force can be reliably secured when the passenger gets off the vehicle, and the braking device can be appropriately used.

The braking device of the parking assistance device includes a first braking device that uses an actuator for maintaining a stop state and a second braking device that does not use an actuator for maintaining a stop state, and the braking switching unit switches the first braking device and the second braking device to a braking force generating state in a case where the operation signal is received, and shifts the first braking device to a braking force non-generating state after it is confirmed that the braking force of the second braking device is generated.

According to this configuration, for example, after the braking force by the second braking device that does not use the actuator for maintaining the stop state is secured, the first braking device that uses the actuator for maintaining the stop state is not driven, in a manner that it is possible to contribute to reduction of the load of the actuator and energy saving of the system while reliably securing the braking force when the passenger gets off the vehicle.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A parking assistance device comprising:
a traveling assistance control unit that causes a vehicle to automatically travel to a designated parking area and park the vehicle;
a reception unit that receives an operation signal for shifting to a state in which traveling control by the traveling assistance control unit can be executed from an operation unit provided in a vehicle interior of the vehicle; and
a braking switching unit that switches a braking device that maintains a stop state of the vehicle to a braking force generating state in a case where the operation signal is received.

2. The parking assistance device according to claim 1, wherein
the braking device includes a first braking device that uses an actuator for maintaining a stop state and a second braking device that does not use an actuator for maintaining a stop state, and
the braking switching unit switches the first braking device and the second braking device to a braking force generating state in a case where the operation signal is received, and shifts the first braking device to a braking force non-generating state after it is confirmed that the braking force of the second braking device is generated.
